(19) United States
(12) Patent Application Publication
(10) Pub. No.: US 2009/0150305 A1
(43) Pub. Date: Jun. 11, 2009

(54) FRANKING SYSTEM INCLUDING A FRANKING MACHINE

(75) Inventors: Dominique Montbrun, Presles (FR); Jean-Marc Alexia, Alfortville (FR); Pascale Duclos, Saint Denis (FR); Patrice Corrette, Saint Denis (FR)

Correspondence Address: PITNEY BOWES INC.;35 WATERVIEW DRIVE, P.O. BOX 3000, MSC 26-22, SHELTON, CT, 06484-8000, US

(73) Assignee: PITNEY BOWES INC., Stamford, CT (US)

(21) Appl. No.: 12/331,757

(22) Filed: Dec. 10, 2008

(30) Foreign Application Priority Data
Dec. 11, 2007 (FR) 0759749

(51) Int. Cl. G06F 17/00

(52) U.S. Cl. 705/410

(57) ABSTRACT

A franking system (postage metering system) is described. The franking system includes a franking machine, further including an analog connection module for connection to a cable communication network. The franking system also includes an adaptation means between the franking machine and at least one wireless communication network.

### RELATED APPLICATIONS

The present application claims priority of French Patent Application No. 0759749, filed Dec. 11, 2007, that is hereby incorporated by reference in its entirety.

### BACKGROUND OF THE INVENTION

The invention generally relates to a franking system including a franking machine adapted to be connected to a cable communication network machines for processing diverse documents.

Franking machines adapted to be connected to the switched telephone network are known in themselves. Such franking machines are able to set up a communication with servers in order to exchange information. For example, that information can be information corresponding to debit or credit operations concerning the franking operations carried out by the franking machine, as well as updates to the software of the machine. It is to be noted that this kind of information exchanged is by nature sensitive, contrary to any other type of data generated by other devices such as copiers, facsimile machines, etc.

The switched telephone network is in particular adapted to transport voice. Digital data can nevertheless also be transmitted by this network. To this end, franking machines include analog modules for connection to the switched telephone network (STN), i.e. modems adapted to transmit digital data between the franking machine and the server. However, during the installation of a franking machine in an office, it is not always easy to connect the franking machine to a telephone jack. Sometimes, buildings are not equipped with telephone jacks in all rooms. This is often the case in old buildings. Installing a telephone jack alongside the franking machine necessitates work to modify the telephone network available in the building and can prove costly. In other cases, the telephone network is not even available in the building concerned.

An object of the present invention is to eliminate at least one of the drawbacks cited above by proposing a franking system including a franking machine, the franking machine including an analog connection module for connection to a cable communication network.

### SUMMARY OF THE INVENTION

The disclosed illustrative embodiments of the present invention provide a franking system (postage metering system) that includes adaptation means between said franking machine and a wireless communication network. Thus the illustrative embodiments of the invention enable connection to a wireless communication network of a franking machine that is normally configured to be connected to a cable communication network, without calling into question the entire design of the machine.

Consequently, the franking system includes means authorizing both a connection to the cable communication network and a connection to the wireless communication network. Thus a user of such a franking machine can connect the franking machine to the cable communication network or to the wireless communication network at will.

In one illustrative embodiment of the invention, the adaptation means are adapted to connect the franking machine to the wireless communication network from the analog connection module. In practice, the adaptation means are placed in a unit external to the franking machine. Thus the franking machine is connected to a wireless communication network without making any modifications to the franking machine.

In practice, the adaptation means include an analog interface adapted to connect said adaptation means to the franking machine, in particular, to the analog connection module, a radio-frequency interface adapted to connect said adaptation means to the wireless communication network, and a data processing module connected between the analog interface and the radio-frequency interface.

Thanks to these provisions the adaptation means which are configured to match the dataflow coming from the franking machine enable to convert data coming from the franking machine (this data is suitable for being transmitted over a telephone line belonging to the cable communication network, for example the switched communication network) into data suitable for being transmitted over a wireless communication network.

According to one feature of the invention, the adaptation means are configured in a way that enables connections with a bit rate substantially lying between 300 and 33600 bits/s, the maximum value being higher than the standard voice transmission bit rate. Thus it is possible to set up a communication between the franking machine and the wireless communication network with a communication bit rate equivalent to the bit rate used for communication of the franking machine with a cable communication network. Furthermore, the adaptation means may be configured for enabling switching from GSM network to GPRS network or vice versa according to network availability.

Furthermore, the adaptation means may be configured for enabling a selection of a network path according to numbers dialed by the franking machine. Furthermore, the adaptation means may be configured for enabling a selection of an Access Point Name (APN) from a list of APNs identifying possible servers with which the franking machine is able to communicate.

According to one feature, the adaptation means are suitable for enabling a connection to one or more wireless communication networks such as the GSM network and the GPRS network. According to another feature, the adaptation means are configured for enabling connections to the franking machine with a bit rate lying from 300 up to 33600 bits/s and providing robustness in the transmission of data between the franking machine and said adaptation means. This configuration makes it possible to select an appropriate modulation mode which will be used by the franking machine for transmitting data with an appropriate bit rate transmission while possibly ensuring that the transmission will be robust to noise occurring during the transmission. This modulation mode may be used by a modem in the franking machine. The robustness comes for example from a trellis encoding of the data.

According to another feature, the adaptation means are configured for enabling the bit rate transmission of data between the franking machine and said adaptation means to be reduced with respect to the maximum bit rate of 33600 bits/s. This reduction in bit rate is particularly useful for transmitting sensitive data such as postal values, billing information and the like since it ensures that the data will be transmitted with a great reliability, while still providing robustness during transmission. This is because transmitting data at too a high bit rate such as 33600 bits/s might incur data losses on the receiving side, and, therefore, a low reliability. The bit rate reduction may be selected after the configuration step of the adaptation means during which a modulation mode has been set.

More particularly, the bit rate reduction may be performed prior to sending any sensitive data from the franking machine. This can be done for instance during a setting up procedure between the franking machine and the adaptation means. During this procedure, the franking machine carries out several tests by sending information with decreasing transmission bit rates respectively, until matching the selected reduced bit rate. This matching is reached when the adaptation means reply to the message sent by the franking machine.

Still according to another feature, the adaptation means are configured for applying an error correction protocol to the data received from the franking machine.

### BRIEF DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention. As shown throughout the drawings, like reference numerals designate like or corresponding parts.

Other features and advantages of the invention will become apparent in the course of the description given hereinafter with reference to the appended drawings and by way of nonlimiting example.

FIG. 1 is a general diagram showing the situation of one illustrative embodiment of a franking system according to the invention.

FIG. 2 is a structural and functional diagram representing the adaptation means of one embodiment of the franking system from FIG. 1.

FIG. 3 is an algorithm representing the operation of the adaptation means from FIG. 2.

### DETAILED DESCRIPTION OF THE EMBODIMENTS

In describing the present invention, illustrative embodiments are described with reference made to the drawings, wherein there is seen in the Figures. While the present invention has been disclosed and described with reference to a single embodiment thereof, it will be apparent, as noted above that variations and modifications may be made therein.

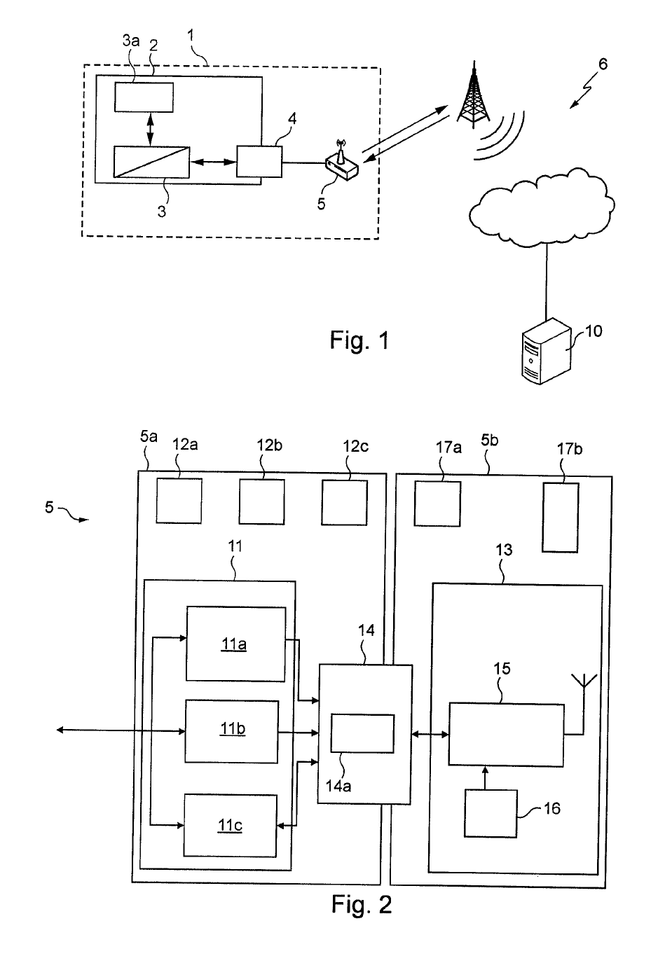

An illustrative franking machine conforming to the invention and the context of the invention are described first with reference to FIG. 1. A franking system 1 for franking documents such as envelopes includes, in a manner that is known in itself, a franking machine 2. The franking machine 2 includes an analog connection module 3 for connection to a cable communication network. Here the analog module 3 is a modem (modulator-demodulator) adapted to convert digital data coming from the franking machine 2 into analog data, and vice-versa, the analog data coming from the telephone line, into digital data intended for the franking machine. The module 3 cooperates with a data stack 3a including different data which is to be sent outside the machine. Such data is for example sensitive data relating to postal values and billing information. Such data comes from different registers in the machine (not shown), such as ascending and descending registers, etc.

Thus the franking machine 2 is able to communicate, for example with a server 10, via a cable communication network, in particular the switched telephone network (STN). The modem 3 is connected to the switched telephone network via a connector 4. In this embodiment, the connector 4 is an RJ11 type connector. This type of connector is very widely used in the switched telephone network. Of course, other types of connector can be employed, for example an RJ45 connector or T-jacks.

The franking system 1 further includes adaptation means 5 between the franking machine 2 and a wireless communication network 6 (FIG. 1). The adaptation means 5 include a converter or gateway that enables to convert the signal used by a cable communication network and produced by a franking machine into a signal used by a wireless communication network. Conversely, the converter is suitable for converting a signal used by a wireless communication network into a signal used by a cable communication network and intended for a franking machine. The signal or flow of data contains sensitive data (accounting and billing data, postal values, etc.), that is data which is of the utmost importance for the addressee and which must not be known by an unauthorized recipient. Such valuable data is transmitted in ciphered form.

The converter 5 is connected to the franking machine 2 by the RJ11 type connector 4. Thus the franking machine 2, which is equipped for connection to a cable communication network, is also equipped for connection to a wireless communication network 6 by means of the converter 5. In this embodiment, the converter 5 is external to the franking machine 2. Consequently, the franking machine is provided with additional equipment for the connection to a wireless communication network, without it being necessary to make modifications to the franking machine. However, due to the sensitivity of data coming from the franking machine the converter cannot be configured as though the data were issued by a facsimile machine or a copier.

In particular, the data has to be streamed through the converter without being buffered or otherwise interrupted, so as to behave as a sustained stream of data between the franking machine and an addressee in the wireless network. Thus a user of the franking machine 2 can connect the franking machine 2 to the cable communication network, and in this case it connects the RJ11 type connector 4 to the cable communication network. The user can also connect the franking machine 2 to the wireless communication network 6. In this case, the user connects the set up converter 5 to the RJ11 type connector 4. The machine is therefore connected to the wireless communication network via the converter 5. In this embodiment the cable communication network is the switched telephone network (STN).

Of course, other cable communication networks can be employed, for example the integrated services digital network (ISDN) or internet network using Voice Over Internet Protocol (VoIP). The converter or gateway 5 is generally used to transport voice. Here the converter or gateway 5 is used to transmit data, thus necessitating transmission speeds higher than those employed for transmission of voice. To this end, the converter or gateway 5 is configured for enabling transmission speeds in a range of values between 300 and 33600 bits/s, for example.

Of course, these transmission speed values are nonlimiting examples. It will be noted that the transmission speed values vary with the evolution of the technology. Thus the configured converter or gateway 5 can achieve transmission speeds as high as 33600 bit/s, whilst being able to adapt to communications between the franking machine 2 and the server 10 at lower transmission speeds. Lower transmission speeds may be used to ensure that all sensitive data will be transmitted and received correctly.

In one embodiment, the converter is adapted to connect the franking machine 2 to either the GSM (Global System for Mobile communication) network or to the GPRS (General Packet Radio Service) network, thereby rendering the franking system self-adaptative to the communication Network. One embodiment of a converter 5 will be described now with reference to FIG. 2. In this example, the converter 5 is a gateway sold by the “e-device” company under the sales reference “BridgeD130” and which has been appropriately configured according to the very specific type of data exchanged in the franking machine field. The converter 5 includes a data flow management unit 5a that is responsible for managing the flow of data exchanged between the franking machine and the converter 5.

The converter also includes a data flow management unit 5b that is responsible for managing the flow of data exchanged between the converter and the wireless network or wireless networks, as well as the terminal or terminals within the network or networks. More particularly, the converter unit 5a includes an analog interface 11. The analog interface 11 is connected to the RJ11 type connector 4 of the franking machine 2 via an analog line 12.

The analog interface 11 has a number of functions. A first function implemented by a functional unit 11a consists in emulating an analog telephone line. To this end, the interface generates a sinusoidal signal, or carrier, that enables the modem 3 to communicate with a terminal, here with the server 10. Thus the franking machine 2 is able to communicate with the converter 5 in the same way that it communicates with a cable communication network.

A second function implemented by a second functional unit 11b is the recovery of dialing coming from the franking machine 2. A third function implemented by a third functional unit 11c consists in transforming the analog data coming from the modem 3 of the franking machine 2 into digital data that will be transmitted over the wireless communication network 6. The first, second and third functions can be implemented by the same means or by different means.

Conversely, digital data intended for the franking machine 3 coming from the wireless communication network 6 is converted into analog data. This analog interface 11 includes the means necessary for adapting the converter 5 to operate at speeds higher than the voice transmission speed (the transmission speed generally used by this type of gateway), in particular a speed of the order of 33.6 kbits.

To this end, the analog interface 11 is adapted to cooperate with data modulation means. Thus the analog interface 11 is adapted to transmit voice and data modulated by the modem 3 (for example modems operating in accordance with the V.21, V.22, V.32bis, V.32 or V.34 standards). Modulation of the data enables the data transmission bit rate to be increased. Thus voice and data are transmitted in the same band of frequencies, between 300 Hz and 3.4 kHz.

In particular, the converter unit 5a includes means 12a enabling to select an appropriate mode of transmission and, more specifically, an appropriate modulation mode. The selected modulation mode defines a transmission speed based on a Quadrature Amplitude Modulation (QAM) providing a synchronous primary bit rate that is capable of reaching a value of 33600 bits/s. This modulation mode which features modulation characteristics (frequency carrier, modulation rate, etc.) is provided with a trellis encoding providing a transmission that is robust to noise.

The trellis encoding improves noise immunity using a convolutional coder to select a sequence of subsets in a partitioned signal constellation. The modulation mode set out in the known per se V.34 standard is particularly efficient in this respect and preferred in this embodiment. In this standard the trellis encoders are four dimensional and are used in a feedback structure where the inputs to trellis encoder are derived from the signal points.

Also, the converter unit 5a includes means 12b for applying a protocol for errors correction to the data stream sent by the modem 3 and received by the converter. Such an error correction protocol is for example conform to the known V42 standard. This standard sets out the Error-correcting procedures for data circuit equipment using asynchronous-to-synchronous conversion. The error correction can be useful to increase the reliability of the transmission. Further, the converter unit 5a includes means 12c which make possible to select a reduced transmission bit rate with respect to the maximum value of 33600 bits/s. This means act as filtering means for rejecting high bit rates.

Reducing the bit rate avoids to lose sensitive data when transmitting such data between the franking machine and the converter 5 and therefore improves the transmission reliability. Such a concern is not encountered when transmitting other types of data coming from other kind of apparatuses as facsimile machines. Also, the trellis encoding used with the modulation mode guarantees a very good signal to noise ratio. The bit rate reduction takes place before streaming sensitive data during a setting up phase. This phase more particularly aims at synchronizing the franking machine and the converter and the franking machine adapts itself to different settings of the configured converter.

Thus, the converter is configured through appropriate means 12c so as to reduce the transmission bit rate between the franking machine and the converter. In a preferred embodiment, the converter is configured with a bit rate of 19200 bits/s which guarantees a high communication reliability. The choice of this value enables to apply to a large set of different franking machines. In particular, the modem of the franking machine is suitable for performing sending tests according to different bit rate values.

In practice, the franking machine modem is able to function in accordance with modulation V92 standard and tests all the following values by descending order: 33600, 31200, 28800, 26400, 24000, 21600, 19200, 16800, 14400, 12000, 9600, 7200, 4800 and 2400 bits/s. When it sends a message with the matched selected value, then the converter 5 sends an acknowledge of receipt informing the modem that this is the value to be used for transmitting sensitive data relating to the franking machine.

The data flow management converter unit 5b includes a radio-frequency interface 13. This radio-frequency interface 13 connects the converter 5 to the wireless network 6 and implements the exchanges of information between the franking machine and the wireless network 6. This radio-frequency interface 13 includes a network module 15 that manages all exchanges of the converter 5 with the wireless network 6.

For example, the network module 15 sends requests for obtaining a resource for the transmission of data. The radio-frequency interface further includes a module 16 for identifying the converter 5 (for example an SIM (Subscriber Identity Module) card) including information concerning the connection of the franking machine 2 to the wireless communication network 6. Thus the network module 15 with the information contained in the identification module 16 assumes responsibility for identification and registration of the franking machine 1 on the wireless network 6 when the franking system 1 is powered up.

A data processing module 14 is inserted between the analog interface 11 and the radio-frequency interface 13. This processing module enables to format data coming from one of the interfaces, in particular to convert that data, which is intended for the other interface thanks to a data stack 14a. This data stack 14 more generally manages the flow of data streaming through the converter. More particularly, the processing module is shared between the two data flow management converter units 5a and 5b.

The converter unit 5b further includes a register 17a storing by default an Access Point Name identifying a terminal address in a wireless network where the data franking machine is to be sent. The unit 5b also includes a register 17b storing a list of Access Point Names (APNs) which identify each an address of a terminal or server in a wireless network. This register is used for selecting an APN among the list of APNs with a view to sending data coming from the franking machine and intended for the corresponding terminal or server. This selection is performed based on the numbers dialed by the franking machine.

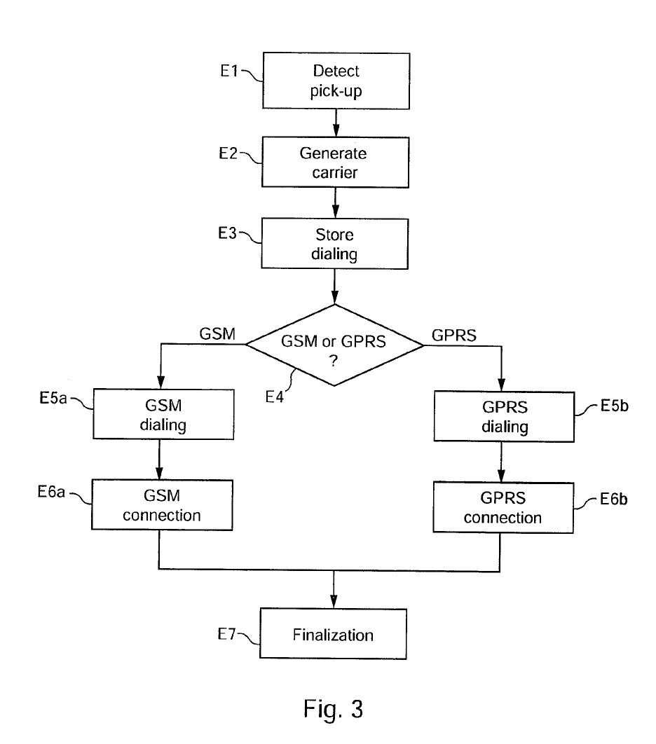

According to these numbers, a network and/or a country is identified which makes it possible then to select the appropriate server APN. The two flow data management converters 5a and 5b allow the converter to be compliant both with any type of franking machine and wireless networks, without modifying the franking machine. The converter thus configured guarantees the integrity of the data transmission. The converter 5 implements a method the algorithm whereof is shown diagrammatically in FIG. 3.

When the modem 3 of the franking machine 2 begins to set up a communication with the server 10, the converter detects it during a detection step E1. The converter then generates the carrier in a generation step E2. The modem 3 of the franking machine 2, detecting the carrier, then begins a dialing step. The processing module 14 of the converter 5 executes a subsequent storage step E3 in order to store the dialing effected by the modem 4. During a decision step E4, as a function of the dialing stored, the processing module 14 recognizes if the connection between the franking machine 2 and the server 10 must be made via the GSM network or via the GPRS network. The processing module serves a switching role, as it were, for selecting the appropriate wireless network.

For example, the dialing for a connection via the GSM network is standard telephone dialing (01 23 44 . . . ) and the dialing for a connection via the GPRS network necessitates a prefix (for example 9999) followed by a call reception country selection code (0000001 for France, 00000003 for Germany, etc.) and followed by the number representing the server 10. Of course, according to settings, the converter 5 can be adapted to be connected only to the GSM network, only to the GPRS network or to other types of wireless network, for example UMTS, EDGE, etc.

When the network used is the GSM network, the processing module 14 executes a step E5a of dialing the stored number, thereby setting up, during a connection step E6a, the connection with the server 10 via the GSM network. Once the connection has been set up, the processing module 14 effects the conversion of the analog data coming from the franking machine 2 into digital data that can be transmitted via the GSM network. The GSM network then assumes responsibility for routing the information to the server 10.

The processing module 14 also effects the opposite conversion of digital data coming from the GSM network (coming from the server 10) into analog data intended for the franking machine 2. When the network used is the GPRS network, the processing module 14 executes a dialing step E5b in order to set up, during a second connection step E6b, a connection between the franking machine 2 and a network using a TCP/IP protocol, for example the Internet.

The gateway 5 is connected to a GPRS network, via an APN of a mobile telephone operator dedicated to the application, in order to obtain an IP address. That IP address is transmitted to the franking machine 2. The gateway 5 then becomes transparent and the franking machine 2 is thus connected to the Internet (and consequently to the server 10). Thus the franking machine 2, having an associated IP address, sets up a connection to a network such as the Internet via an access point or APN of a mobile telephone operator.

In this case, the processing module 14 formats data coming from the franking machine 2 so that it can be transmitted over the network using the TCP/IP protocol and vice-versa. The franking system through the gateway suitably configured is able the get the APN among a prestored list of APNs (17b) in the gateway. Once the franking machine 2 decides that the connection with the server 10 is finished, the processing module 14 executes a step E7 of finalization of the connection between the franking machine 2 and the wireless communication network 6.

The connection can be finalized at the request of the server if an error has been detected, for example an error in the identification of the franking machine 2. Thanks to the invention, it is possible to connect with a wireless communication network a franking machine that is adapted for connection with a cable communication network. Moreover, it is not necessary to make any modification to the franking machine since the gateway or adaptation means is suitably set up and configured to comply with franking machines' dataflow What is more, the wireless communication networks can vary. Thus wireless communication networks via which the franking machine communicates with the server can be different, for example the EDGE or UMTS network.

Of course, numerous modifications can be made to the embodiment described hereinabove without departing from the scope of the invention.

What is claimed is:

1. A franking system comprising:
a franking machine, including an analog connection module for connection to a cable communication network; and
an adaptation means between said franking machine and at least one wireless communication network.

2. The franking system according to claim 1, wherein,
the adaptation means are adapted to connect the franking machine to the wireless communication network from the analog connection module.

3. The franking system according to claim 1, wherein,
the adaptation means are disposed in a unit external to the franking machine.

4. The franking system according to claim 1, wherein,
the adaptation means further comprises:
an analog interface adapted to connect said adaptation means to the franking machine;
a radio-frequency interface adapted to connect said adaptation means to the wireless communication network; and
a data processing module connected between the analog interface and the radio-frequency interface.

5. The franking system according to claim 1, wherein,
said adaptation means are configured for enabling connections between the franking machine and the adaptation means with a bit rate substantially lying between 300 and 33600 bits/s, and/or enabling switching from GSM network to GPRS network or vice versa according to network availability, and/or enabling selection of network path according to numbers dialed by the franking machine, and/or enabling selection of an Access Point Name (APN) from a list of APNs.

6. The franking system according to claim 1, wherein,
the cable communication network is the switched telephone network.

7. The franking system according to claim 1, wherein,
said at least one wireless communication network is the GSM network.

8. The franking system according to claim 1, wherein,
said at least one wireless communication network is the GPRS network.

9. The franking system according to claim 1, wherein,
the adaptation means are configured for enabling connections to the franking machine with a bit rate lying from 300 up to 33600 bits/s.

10. The franking system according to claim 1, wherein,
the adaptation means are configured for enabling connections to the franking machine that provide robustness in the transmission of data between the franking machine and said adaptation means.

11. The franking system according to claim 9, wherein,
the adaptation means are configured for enabling the bit rate transmission of data between the franking machine and said adaptation means to be reduced with respect to the maximum bit rate of 33600 bits/s.

12. The franking system according to claim 11, wherein,
the adaptation means are configured for enabling a reduction in bit rate before any transmission of sensitive data by the franking machine.

13. The franking system according to claim 12, wherein,
the bit rate reduction takes place during a setting up procedure.

14. The franking system according to claim 1, wherein,
the adaptation means are configured for applying an error correction protocol to the data received from the franking machine.

15. A franking system comprising:
a franking machine, including an analog connection module for connection to a cable communication network; and
a communications adapter operatively connected to the analog connection module and at least one wireless communication network.
